(19) United States
(12) Patent Application Publication
(10) Pub. No.: US 2006/0159810 A1
(43) Pub. Date: Jul. 20, 2006

(54) Method for producing a food product

(76) Inventors: Marialuci Almeida, Bourbonnais, IL (US); Flavio Galhardo, Manteno, IL (US)

Correspondence Address: JONES DAY, 77 WEST WACKER, CHICAGO, IL, 60601-1692, US

(21) Appl. No.: 11/038,988

(22) Filed: Jan. 20, 2005

(51) Int. Cl. A23L 3/32

(52) U.S. Cl. 426/237; 426/634

(57) ABSTRACT

An oil-bearing biological material such as soybeans is subjected to microwave energy in the presence of an organic extractant. The oil will be expressed into the extractant, leaving soybean meal. The moisture content of the soybeans, the pressure level of the solvent, and the microwave energy density all can be preselected in a single unit process to produce a soybean meal product having a protein dispersibility index value within a preferred range.

### BACKGROUND OF THE INVENTION

This invention relates to a method for producing a food product, particularly such a food product that can be useful as an animal feed product. More particularly, this invention relates to a method for producing a high-quality, high protein food product in which certain anti-nutritional factors have been deactivated, and which product has a protein dispersibility index in a desired range.

The use of soybean-based products as an ingredient in livestock feed is well known. As is known in the art of agricultural feed materials, soybeans are processed to separate out the soybean oil, which can be used in a variety of products for human consumption. The remaining soybean meal can be used for a variety of food products, and in particular in the preparation of animal feed products.

In accordance with prior art soybean processing methods, the soybeans are optionally dehulled, and then cracked, heated, and flaked. The oil content of the resulting soybean flakes is then reduced by extraction with organic solvents such as hexane or homologous hydrocarbon solvents, to 1% or less on a commercial basis. The extracted flakes are separated from the oil-bearing solvent, and the flakes are then heated a second time in the presence of live steam and ground into meal. This second heating step, known in the art as toasting, can increase the nutritional quality of the soybean meal by breaking down certain proteins to make them more digestible by certain animals. The toasting step also is known to deactivate certain anti-nutritional factors, such as trypsin inhibitors, as reported, for example, by R. Rajko et al., J. Agric. Food Chem., Vol. 45, No. 9, 3565-3569 (1997). Trypsin and chymotrypsin inhibitors are two of the most thermolabile anti-nutritive constituents in soybean meal (the others are lectins and urease). The trypsin and chymotrypsin inhibitors form inactive complexes with the soy protein in the ileum of an animal, and they inhibit the proteolytic action of the pancreatic enzyme trypsin. (Liener, I. E., Journal of the American Oil Chemists Society, March, 1981.)

Soybean meal produced in this manner is highly regarded as a premium feed product because of its high digestibility, high energy content and consistency. According to a report published by the National Oilseed Processors' Association at http://www.nopa.org/content/oilseed/soybean_use_livestock.pdf, about 50% of soybean meal is used for livestock feed, 25% is used for swine feed, 19% is used for beef and dairy cattle, and the remainder goes to other feed products and other uses. Over 80% of the soybean meal produced in the U.S. is dehulled and processed as described above in very large state-of-the-art solvent extraction facilities. High quality standards and an efficient production, handling and shipping industry in the U.S. ensure that export customers receive a consistent and high value product.

Properly processed dehulled soybean meal is an excellent source of protein and is used extensively in feed for swine, beef and dairy cattle, poultry, and aquaculture. Feed rations including soybean meal and other ingredients are formulated to fit the nutritional needs of each breed of animal at its particular stage of the life cycle. Soybean meal is ideal for high-energy rations such as broiler, turkey, and pig starter feeds. For young animals and birds, dehulled soybean meal is the preferred product.

Trading rules for the purchase and sale of soybean meal are established by the National Oilseed Processors Association (NOPA), and published by NOPA in its official yearbook. Also included in the yearbook are information on contracts, quality, sampling laboratory analysis, weights and measures, and shipping. This industry information is available at http://www.asasoya.org/uses/meal.htm.

From the foregoing, it may be seen that quality of soybean meal is of critical importance in the formulation of livestock feed products. As reported by Keith C. Behnke, Professor of Feed Science at Kansas State University at http://www.asa-europe.org/pdf/ussbm.pdf, two steps in the meal manufacturing process that can affect meal quality after oil extraction are desolventizing and toasting.

Toasting is an area of concern for producers of soy meal. Soybean meal must be properly and homogeneously heated during the toasting step to provide optimum protein nutrition for the intended use of the meal product. When a volume of soy meal is heated with conventional heating means such as convection and conduction modes, the surfaces of the volume are heated more than the interior of the volume, such that the volume is not heated homogeneously. If the meal is over-toasted, there is great risk that certain amino acids, particularly lysine, will have significantly reduced availability to the animal. This is due to the fact that during the toasting process lysine and some other amino acids can become chemically bonded to certain carbohydrates to form indigestible complexes. The result is that the animal will demonstrate a deficiency in lysine or other amino acid, even though it appears that the formula is adequate in the amino acid. On the other hand, if the meal is under-toasted, there can be present excessive amounts of anti-nutritional factors such as trypsin inhibitors and urease, which can reduce the digestibility of the meal and also can result in amino acid deficiencies in the animal.

Several rapid and accurate tests can be used by the buyer to ensure that the level of toasting is appropriate for the intended use of the product. One such test is the protein dispersibility index (PDI). The PDI measures the amount of soybean meal protein dispersed in water after blending a sample with water in a high speed blender. The PDI has been used in the feed industry for over 25 years, but is only very recently gaining attention as a method for determining variations in quality of soybean meal for feed use (Soybean Meal Infosource Newsletter, Sept 2004, United Soybean Board publication).

A recent investigation reported by Swick, R. A. “An Update on Soybean Meal Quality Considerations,” American Soybean Association, 541 Orchard Road, #11-03 Liat Tower, Singapore, examined the ability of the PDI test to predict the growth rate of chicks fed soybean meal samples heated by autoclaving for various lengths of time. The PDI results were then compared to protein solubility as measured in 0.2% KOH, and urease levels as measured by the rise in pH. In this study, several samples having KOH solubility above 90% and high urease levels gave varying growth rates in chicks. The PDI test, however, was able to predict the growth-supporting potential of these meals. These results suggest that the PDI test may be useful to further distinguish quality of soy bean meal samples that are considered of high quality based on urease and KOH measurements.

Batal A. B., Douglas, M. W., Engram, A. E. and Parsons, C. M., 2000, “Protein Dispersibility Index as an Indicator of Adequately Processed Soybean Meal”, Poultry Science, 79, 1592-1596, reported that the PDI test demonstrated more consistent responses to heating of soy flakes than did the urease or KOH protein solubility tests. The inconsistent and non-linear nature of the urease index to heating of soybean flakes contributes to inconsistent research results on the maximum acceptable levels of urease activity in soybean meal. As reported by Batal et al., soybean meal with a PDI between 45 and 50% and urease between 1.65 to 1.8 pH unit yielded maximum chick growth performance in two of three assays.

It is also known that heat treatment can increase the degradability of animal feed protein (see e.g. Marshall D. Stern, Feedstuffs, 9 Nov. 1981, pp.24-29). Most of the treatments described have been carried out at temperatures between 120 and 150° C. which temperatures are achieved by mechanical friction, such as in extruding machines or autoclaves. The periods of treatment are long, from about 15 minutes to several hours. Further, these treatment methods do not apply heat homogeneously to the soybean samples.

U.S. Pat. No. 5,002,784 and U.S. Pat. No. 5,338,557, incorporated herein by reference in their entireties, disclose the use of microwave energy with a non-aqueous solvent to extract desired oils from natural plant and animal products, such as peppermint, sea parsley, cedar, garlic, and rainbow trout. As explained therein, the microwave energy generates a sudden temperature increase in the glandular and sometimes vascular systems of the biological materials. The glandular systems rupture and the oils are expressed into the cooler organic extractant. These references do not teach or suggest any utility of the residual biological materials after the expression of the desired oils.

Rajko, et al., J. Agric. Food Chem., Vol. 45, No. 9, pp.3565-3569 (1997) disclose a process in which microwave energy is used to reduce anti-nutritive agents in soybeans.

Hernandez-Infante, et al., Plant Foods for Human Nutrition, Vol. 52, pp. 199-208 (1998) discloses that microwave heating effectively inactivates toxic substances in wet soybeans.

It is thus one object of the invention to provide a method of producing a food product material by extracting oil from a plant product, so that the residual plant material is suitable for use as an ingredient in a feed product.

It is another object of the invention to provide a method of producing a food product material having a desired protein dispersibility index.

It is still another object of the invention to provide a method of producing a food product in which certain anti-nutritional factors have been deactivated.

It is still another object of this invention to provide a method of producing a food product in a single unit process in which certain operating parameters of the method can be optimized at different values to produce food products having different desired properties.

### SUMMARY OF INVENTION

The present invention relates to a method for producing food materials, and in particular feed protein materials having varying feed proteins in relation to their dispersibility indices. In accordance with the invention, a method of producing a food product comprises the steps of providing a quantity of an oil-containing biological material, contacting the oil-containing biological material with an extractant to form a mixture, exposing the mixture to microwave energy sufficient to extract the oil from the biological material into the extractant, separating the oil-containing extractant from the remaining biological material, and using said remaining high quality biological material in the preparation of a food product having a preferred PDI range and inactivated anti-nutritional factors. The extractant preferably does not absorb significant quantities of microwave energy. Operating parameters that can be controlled during the process include the moisture content of the flakes prior to solvent extraction; the pressure applied during the extraction process; and the energy applied during the extraction process.

This invention can be used with a variety of oil-bearing biological materials, and finds particular utility with oil-bearing seeds and grains, especially soybean-based materials. The material can be sub-divided, preferably into flakes, although chopping, grinding, and comminution also can be used. The flaked soybean material is treated to achieve a desired moisture content, and then submitted to microwave energy in the presence of an extractant, preferably pressurized liquid butane. The sudden temperature increase in the vascular system of the soybean material can cause rupture of the vascular membranes, allowing the oil contained therein to be expressed into the surrounding extractant. Process parameters can be selected so that the remaining soybean meal has a protein dispersibility index within a desired range. In addition, more of the anti-nutritional factors in the soybean meal will be deactivated.

In accordance with the inventive method, the biological material is sent to a microwave cavity that is capable of being pressurized, as is known in the art. A quantity of extractant is pumped through the cavity, and microwave energy is applied to the cavity. The biological material will be heated by the microwave energy, while the extractant, being substantially transparent to microwave energy, remains cooler. The oil is expressed from the hotter biological material to the relatively cooler extractant. The oil-bearing extractant is separated from the biological material; for example, it can be transferred to an evaporator, where the extractant is evaporated away from the oil, and transferred to a condenser and then to a reservoir, while the separated oil is reserved as product. The remaining biological material can be treated further, if desired, to remove any last traces of residual extractant. The remaining biological material is then suitable for use as a component of a high quality food product, and in particular an animal feed product.

### DESCRIPTION OF THE FIGURES

The present invention can be more readily understood by reference to the Figures, wherein:

FIG. 1 is a schematic illustration of a system suitable for carrying out the method of the present invention; and

FIGS. 2A-I are three-dimensional surface plots of changes of PDI as functions of moisture content, pressure, and energy.

### DETAILED DESCRIPTION OF A PREFERRED EMBODIMENT

In accordance with the invention, a quantity of an oil-containing biological material is contacted with an extractant under pressure to form a mixture, the mixture is exposed to microwave energy, the microwave energy being sufficient to extract oil from the biological material into the extractant, and the oil-containing extractant is separated from the remaining biological material, the pressure, moisture content, and applied energy levels being selected such that the remaining biological material has a PDI value within a desired range so as to be useful in the preparation of a feed product.

It is within the scope of this invention to choose operating parameters that will account for these variables to produce optimum food products for an intended purpose, and in particular, food products for use in animal feed products having desired protein dispersibility indices. Such operating parameters can include moisture content, pressure, and applied energy level.

Preferred biological materials include oil-bearing seeds and grains, and particularly those having a nutritionally significant quantity of thermolabile protein, such as soybeans. For the sake of clarity and ease of description, the invention will be described herein for the embodiment wherein the biological material is soybeans, but it will be appreciated that other biological oil-bearing materials might be suitable for use with the present invention. In such biological materials, the oil may be contained in fatty globules in the material's vascular or glandular systems. The biological materials may have varying fat contents and moisture contents. The moisture content can range from about 4% to about 45% by weight. The moisture content can be adjusted by the operator by soaking or placing the material in a controlled ambient atmosphere for a prescribed period of time until the desired moisture content is achieved. For the sake of clarity and ease of description, the invention will be described herein for the embodiment wherein the biological material is soybeans, but it will be appreciated that other biological oil-bearing materials might be suitable for use with the present invention.

Prior to be exposed to microwave energy, the biological material can be subdivided such as by flaking, chopping, grinding, or commination. For soybean materials, flaking is preferred.

The microwave energy can be provided by a standard microwave generator such as a 2 kW generator, although it will be appreciated that different power levels can be used depending on the quantity of biological material being extracted, the type of biological material, and the nature of the solvent. The energy density delivered to the biological material can be in the range of about 500-3000 J/g, although this also can be varied with the quantity of biological material being extracted, the type of biological material, the geometry of the material in the microwave cavity, and the nature of the solvent.

Any extractant that extracts oil from the ruptured biological material can be effective in the system of the present invention. Particularly preferred are those extractants that are transparent in whole or in part to the applied microwave energy. Extractants useful in the present invention include certain organic extractants and CO₂. The organic extractants include, without limitation, alkanes, alcohols, ketones, petroleum ether, halogenated hydrocarbons, and mixtures thereof. Suitable alkanes include liquid butane, isobutane, hexane, isohexane, liquid propane, one or more mixtures of propane with either butane or isobutane, commercially known as isopropane, and mixtures thereof. Of these, liquid butane and hexane are preferred for use with soybean materials. For organic extractants, the extractant mixture can be pressurized anywhere from vacuum up to about 120 psi while the microwave energy is applied.

For CO₂ extractant, the pressures can be maintained such that the CO₂ is either liquefied or in the supercritical state, as is known in the art. For supercritical CO₂, the pressure can range up to about 11,600 psi. Those skilled in the art will understand methods for maintaining CO₂ in either the liquefied or supercritical state, as desired.

If the extractant does not absorb microwave energy, it will remain cool relative to the oil being extracted, and relative to the biological material. The extractant can be contacted with the biological material several times after exposure to the microwave energy, to make sure that as much oil as possible is extracted from the biological material. The oil-containing extractant is then separated from the remaining biological material.

Due to the cool nature of this microwave extraction process, it is possible to leave the soybean protein almost intact in the resulting irradiated soybean meal, yielding in this way consistently high levels of the protein dispersibility index. At the same time, the absorbed microwave energy is sufficient to deactivate at least some of the antinutritional enzymes present in the soybean meal. The exact mechanism of this deactivation is not fully understood at this time; it is known, however, that different anti-nutritional enzymes require different minimum absorbed microwave energy for deactivation, as reported in Rackis, J. J., et al., Nutritional and Toxicological Significance of Enzyme Inhibitors in Foods, Friedman, M., Ed., Plenum Press, N.Y., pp. 299-350 (1986). As described above, and as understood more fully from the examples below, the moisture content of the biological material used for each extractant, the pressure, and the energy density, each can be optimized to facilitate the enzyme deactivation in shorter temperature exposure. For most feed component uses, the preferred PDI will be in the range of about 4-95%, with the preferred value depending on the intended use of the product, i.e., on the type and age of animal to which it will be fed. Deactivation of anti-nutrients can be gauged by urease levels; a preferred urease level is in the range of 0.0-2.0 increased pH units, as measured by AOCS method Ba10-65.

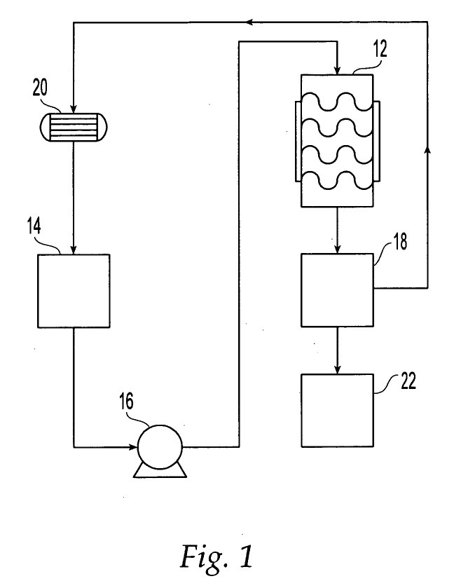

FIG. 1 schematically illustrates a system suitable for practicing the method of the present invention. A quantity of a biological material such as soybeans is subdivided into smaller particles such as flakes, and then pretreated such as by soaking or controlled humidification until it reaches a predetermined moisture content. For soybeans, the preferred moisture content can be in the range of about 4-45% by weight. The moisturized soybeans are sent to microwave cavity 12 of a microwave assisted process system. An extractant such as butane is transferred from reservoir 14 via pump 16 to cavity 12, such that the extractant in the cavity reaches a desired pressurization level. Microwave energy is then applied to the cavity at a preselected energy density, for a predetermined duration. During this step, oil is extracted from the soybeans into the extractant. The oil-bearing extractant is drained from the cavity into an evaporator 18. In this unit, the extractant is evaporated off and passes through condenser 20 back to reservoir 14. The remaining oil is transferred to holding tank 22. The soybean meal remaining in the cavity 12 will have a desired PDI, based on the moisture content, pressure, and applied energy.

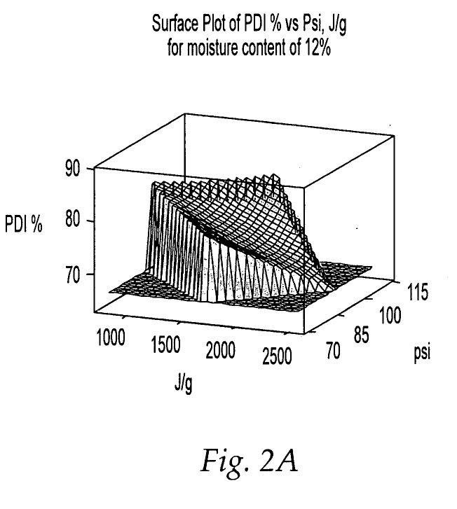

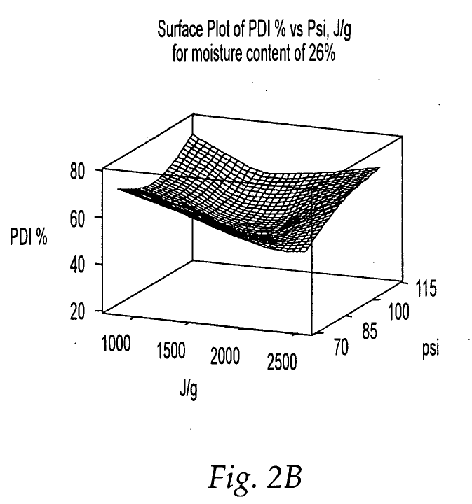

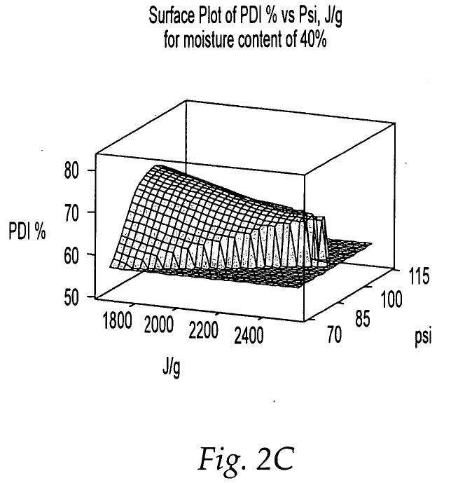

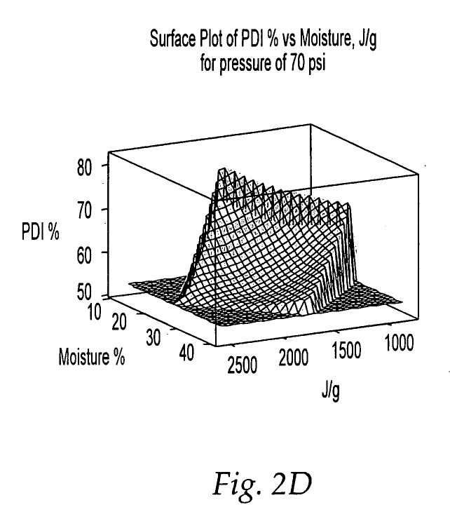

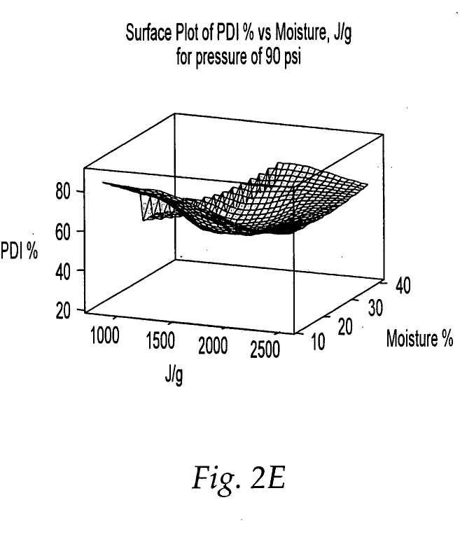

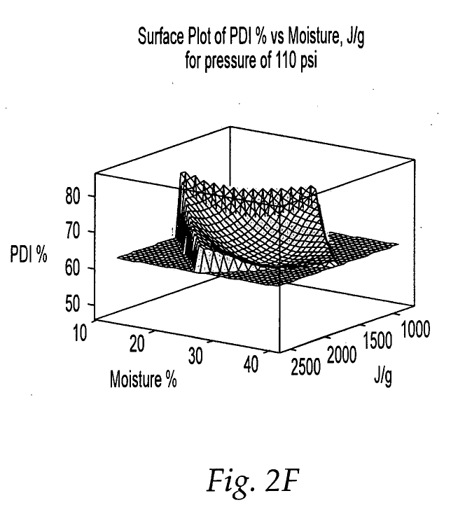

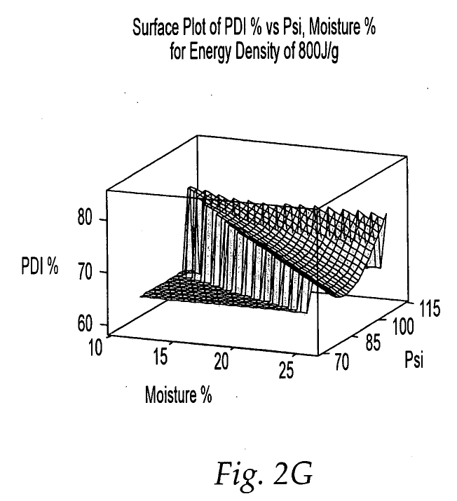

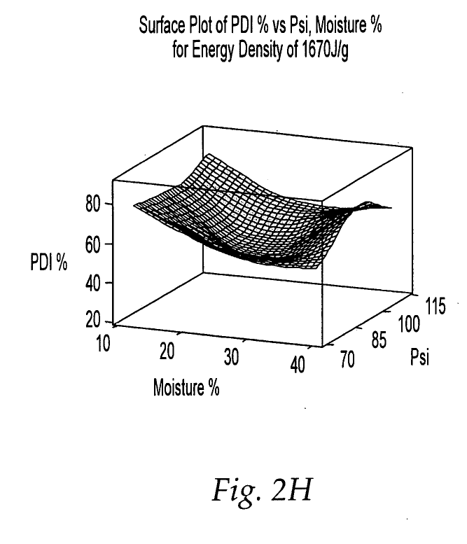

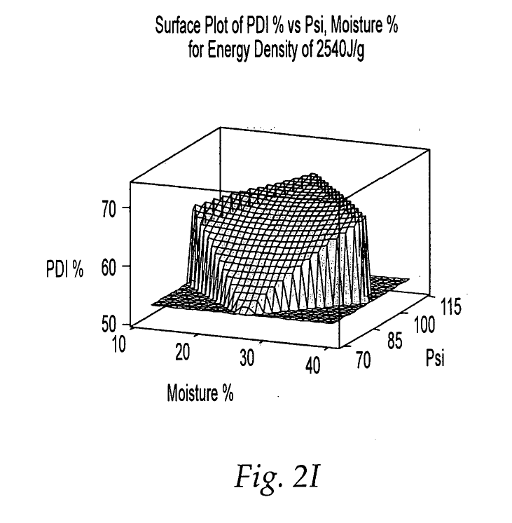

FIGS. 2A-I illustrate the relationship between the PDI level achieved and variations in moisture content, pressure, and energy for the treatment of soybean material. FIGS. 2A-C are surface plots of PDI as a function of pressure and energy for moisture contents of 12%, 26%, and 40%, respectively; FIGS. 2D-F are surface plots of PDI as functions of moisture and applied energy levels for liquid butane pressures of 70 psi, 90 psi, and 110 psi, respectively; and FIGS. 2G-I are surface plots of PDI as functions of moisture level and pressure at applied energy densities of 800 J/g, 1670 J/g and 2540 J/g, respectively. Those skilled in the art will recognize that other surface plots could be generated based on empirical data for other values of moisture content, pressure, and energy density. The plots can then guide the process operator in choosing operating parameters that will produce a soybean meal product having a desired PDI based on these preselected operating parameters.

### EXAMPLES

Soybean flake samples of 338 g to 400 g were treated by placement in controlled ambient atmosphere to achieve desired moisture contents of 12%, 26%, or 40%. The moisturized flakes were submitted to a microwave extraction process using butane at pressures of either 70 psi, 90 psi, or 110 psi. The energy density delivered to the beans was either 800 J/g, 1670 J/g, or 2540 J/g, through a 2 kW microwave generator. After 32-44 minutes of microwave exposure, the oil-bearing liquid butane was separated from the flakes and the soybean flakes were manually removed from the microwave cavity. The meal samples so produced were analyzed for trypsin inhibitor, urease activity and PDI. Urease index and PDI were determined by American Oil Chemist's Society (AOCS) method Ba 10-65. Urease is reported in units pH increase at 25° C. Trypsin inhibitor analyses were determined on triplicate soybean meal flakes samples; trypsin inhibitor (TI) is reported as TIU/mg dry matter.

The results are shown in Table 1 for the production of low-fat meal, having a fixed oil content of about 1.15%.

TABLE 1

| Example No. | Moisture % | J/g | psi | Urease | PDI % | TIU/mg |
|---|---|---|---|---|---|---|
| 1 | 12 | 800 | 90 | 1.77 | 84.4 | 59.1 |
| 2 | 12 | 800 | 90 | 1.73 | 82.3 | 49 |
| 3 | 12 | 1670 | 90 | 1.68 | 88.5 | 58.2 |
| 4 | 12 | 1670 | 90 | 1.75 | 84.7 | 50.1 |

For the production of “full fat microwaveable soybean meal” having an oil content of about 4-13%, there can be more flexibility in processing conditions. Production results for “full fat microwaveable soybean meal” are shown in Table 2.

TABLE 2

| Example | moisture | | | | | | |
|---|---|---|---|---|---|---|---|
| No. | % | J/g | psi | Urease | PDI % | TIU/mg | Fat % |
| 5 | 12 | 1670 | 90 | 1.66 | 65.6 | 37.6 | 13.2 |
| 6 | 12 | 2540 | 90 | 1.79 | 66.3 | 41.1 | 12.7 |
| 7 | 12 | 2540 | 90 | 1.73 | 66.5 | 38.9 | 13.3 |
| 8 | 26 | 800 | 70 | 1.69 | 74.3 | 46.9 | 6.8 |
| 9 | 26 | 800 | 70 | 1.53 | 69.5 | 46.9 | 7.6 |
| 10 | 26 | 800 | 70 | 1.67 | 70.5 | 44.4 | 7 |
| 11 | 26 | 800 | 90 | 1.47 | 63 | 37.8 | 13.6 |
| 12 | 26 | 800 | 90 | 1.62 | 59.6 | 37 | 12.5 |
| 13 | 26 | 1670 | 70 | 1.63 | 71 | 46.7 | 7.2 |
| 14 | 26 | 1670 | 70 | 1.48 | 64.1 | 46.3 | 5.2 |
| 15 | 26 | 1670 | 70 | 0.96 | 51.4 | 32.6 | 5.1 |
| 16 | 26 | 1670 | 70 | 1.2 | 51.9 | 37.4 | 5.1 |
| 17 | 26 | 1670 | 90 | 1.27 | 63.9 | 42.7 | 5.8 |
| 18 | 26 | 1670 | 90 | 1.03 | 61.9 | 37.9 | 5.4 |
| 19 | 26 | 1670 | 90 | 1.57 | 59.9 | 39.6 | 6.6 |
| 20 | 26 | 1670 | 90 | 1.55 | 59.5 | 42.5 | 7.3 |
| 21 | 26 | 1670 | 90 | 1.53 | 59.8 | 37.2 | 7.1 |
| 22 | 26 | 1670 | 90 | 1.5 | 61 | 40.5 | 6.7 |
| 23* | 26 | 1670 | 90 | 0.04 | 22.8 | 1.8 | 6.5 |
| 24* | 26 | 1670 | 90 | 0.01 | 22.5 | 3.5 | 7.9 |
| 25 | 26 | 1670 | 110 | 1.78 | 68.4 | 46.5 | 5 |
| 26 | 26 | 2540 | 70 | 1.32 | 55 | 31.9 | 5.2 |
| 27 | 26 | 2540 | 70 | 1.25 | 51.3 | 26.9 | 5.5 |
| 28 | 26 | 2540 | 90 | 1.72 | 61.4 | 40.3 | 13 |
| 29 | 26 | 2540 | 90 | 1.71 | 63.6 | 37.6 | 13.1 |
| 30 | 26 | 2540 | 90 | 1.45 | 62.1 | 33.4 | 4 |
| 31 | 40 | 1670 | 70 | 1.45 | 59.5 | 37 | 13.2 |
| 32 | 40 | 1670 | 70 | 1.38 | 53.7 | 38.4 | 13.1 |

*Microwave heating was intermittent, with about 5 minute intervals between applications of microwave energy.

There has been disclosed herein a method of processing soybeans to produce a soybean meal product having a desired PDI, the method involving exposing the soybeans to microwave energy in the presence of an extractant, and wherein a desired PDI range can be achieved by preselection of moisture content, energy density and pressure in the microwave cavity. The resulting soybean meals can have the different Protein Dispersibility Indexes so desired in the soybean meal market, and urease levels as accepted for the maximum growth of an animal whose feed includes this product. This control of product PDI can be obtained with a minimum of processing changes in a single unit oil extraction process: the cavity pressure as well as the energy delivered to the beans are each easily adjusted in existing microwave cavity apparatus, and moisture content can be controlled by the processor.

While a preferred embodiment has been disclosed, those skilled in the art will appreciate that other modifications can be made to the invention without departing from the concepts disclosed herein. Such modifications and equivalents are to be considered as falling within the scope of the following claims.

What is claimed is:

1. A method of producing a food product, the method comprising the steps of providing a quantity of an oil-containing biological material;
contacting said quantity of oil-containing biological material with an extractant to form a mixture,
exposing said mixture to microwave energy, said microwave energy being sufficient to extract said oil from said biological material into said extractant,
separating said oil-containing extractant from said remaining biological material, and using said remaining biological material in the preparation of a feed product.

2. The method of claim 1 wherein said remaining biological material is used in the preparation of an animal feed product.

3. The method of claim 1 wherein said oil-containing biological material comprises oil-containing seeds and grain materials.

4. The method of claim 3 wherein said oil-containing biological material comprises soybean material.

5. The method of claim 1 wherein said extractant is at least partially transparent to microwave radiation.

6. The method of claim 1 wherein said extractant is an organic extractant.

7. The method of claim 6 wherein said organic extractant is selected from the group consisting of alkanes, alcohols, ketones, petroleum ether, halogenated hydrocarbons, and mixtures thereof.

8. The method of claim 7 wherein said alkanes are selected from the group consisting of butane, isobutane, hexane, isohexane, isopropane, propane, and mixtures thereof.

9. The method of claim 1 wherein said extractant is selected from liquefied CO₂ and supercritical CO₂.

10. The method of claim 1 wherein said oil-containing biological material is subdivided prior to being contacted with said extractant.

11. The method of claim 1 wherein the microwave energy to which said mixture is exposed is in the range of about 500-3000 J/g.

12. The method of claim 1 wherein said mixture is pressurized while being exposed to said microwave radiation.

13. The method of claim 6 wherein said mixture is pressurized while being exposed to said microwave radiation and said pressure is in the range of vacuum to about 120 psi.

14. The method of claim 9 wherein said extractant is supercritical CO₂ and said mixture is pressurized up to about 11,600 psi while being exposed to said microwave radiation.

15. The method of claim 1 wherein said remaining biological material has a protein dispersibility index in the range of about 4-95%.

16. The method of claim 15 wherein said remaining biological material has a urease level in the range of about 0.0-2.0 increased pH units.

17. The method of claim 1 wherein the moisture content of the biological material is adjusted prior to being contacted with the extractant.

18. The method of claim 17 wherein said moisture context is adjusted to a level of about 4-45% by weight.

19. A method of producing a food product component having a protein dispersibility index value within a desired range, the method comprising the steps of
providing a quantity of an oil-containing biological material;
adjusting the moisture content of said biological material;
contacting said quantity of oil-containing biological material with an extractant to form a mixture,
exposing said mixture to microwave energy, said microwave energy being sufficient to extract said oil from said biological material into said extractant, and
separating said oil-containing extractant from said remaining biological material,
said remaining biological material being suitable for use as a component in the preparation of a food product.

20. The method of claim 19 wherein said oil-bearing biological material comprises oil-bearing seeds and grains.

21. The method of claim 20 wherein said oil-containing biological material comprises soybean material.

22. The method of claim 19 wherein said extractant is at least partially transparent to microwave radiation.

23. The method of claim 19 wherein said extractant is an organic extractant.

24. The method of claim 23 wherein said extractant is selected from the group consisting of alkanes, alcohols, ketones, halogenated hydrocarbons, petroleum ether, and mixtures thereof.

25. The method of claim 24 wherein said alkanes are selected from the group consisting of butane, isobutane, hexane, isohexane, isopropane, propane, and mixtures thereof.

26. The method of claim 18 wherein said extractant is selected from liquefied CO₂ and supercritical CO₂.

27. The method of claim 19 wherein said biological material is subdivided prior to being contacted with said organic extractant.

28. The method of claim 19 wherein the microwave energy to which said mixture is exposed is in the range of about 500-3000 J/g.

29. The method of claim 19 wherein said mixture is pressurized while being exposed to said microwave radiation.

30. The method of claim 23 wherein said mixture is pressurized while being exposed to said microwave radiation and said pressure is in the range of vacuum to about 120 psi.

31. The method of claim 26 wherein said extractant is supercritical CO₂ and said mixture is pressurized up to about 11,600 psi while being exposed to said microwave radiation.

32. The method of claim 19 wherein said separated biological material has a protein dispersibility index in the range of about 4-95%.

33. The method of claim 32 wherein said remaining biological material has a urease level in the range of about 0.0-2.0 increased pH units.

34. The method of claim 19 wherein said moisture content is adjusted to a level of about 4-45% by weight.

35. In a method of preparing a food product, the method comprising the steps of providing an oil-containing biological material, extracting oil from the material, and treating the material to obtain a material having a protein dispersibility index within a desired range, the improvement comprising
carrying out the extraction and treating step in a single process unit wherein the biological material is contacted with an extractant and the treatment step comprises irradiation with microwave energy, such that oil is extracted from the biological material into the extractant, and whereby the biological material remaining after separation of the oil-containing extractant has a protein dispersibility index within a range of about 4-95%.

36. The method of claim 35 wherein said remaining biological material has a urease level in the range of about 0.0-2.0 increased pH units.

37. The method of claim 35 wherein the oil-containing biological material comprises oil-containing seeds and grains.

38. The method of claim 37 wherein the oil-containing material comprises soybeans.

39. The method of claim 35 wherein the moisture content of the oil-containing biological material is adjusted prior to the oil-extraction step.

40. The method of claim 39 wherein the moisture content is adjusted to about 4-45% by weight.

41. The method of claim 35 wherein the microwave energy is in the range of about 500-3000 J/g.

42. The method of claim 35 wherein said extractant is substantially transparent to microwave energy.

43. The method of claim 35 wherein said extractant is an organic extractant.

44. The method of claim 43 wherein said organic extractant is selected from the group consisting of alkanes, alcohols, ketones, petroleum ether, halogenated hydrocarbons, and mixtures thereof.

45. The method of claim 44 wherein said alkanes are selected from the group consisting of butane, isobutane, hexane, isohexane, isopropane, propane, and mixtures thereof.

46. The method of claim 35 wherein said extractant is selected from liquefied CO₂ and supercritical CO₂.

47. The method of claim 35 wherein said unit is pressurized during the period of microwave energy exposure.

48. The method of claim 47 wherein said extractant is an organic extractant and said pressure is in the range of vacuum to about 120 psi.

49. The method of claim 47 wherein said extractant is supercritical CO₂ and said pressure is up to about 11,600 psi.

50. The method of claim 35 wherein said biological material comprises soybean material and said extractant is selected from the group consisting of butane and hexane.

51. The method of claim 35 comprising the further step of using said remaining biological material in the production of an animal feed product.
